(19) United States
(12) Patent Application Publication
(10) Pub. No.: US 2003/0152484 A1
(43) Pub. Date: Aug. 14, 2003

(54) Means and method of preserving legal rights by obtaining independent DUI test

(76) Inventor: David L. Heilman, Greenacres, FL (US)

Correspondence Address: Norman Friedland, Suite 400, 11300 US Highway One, North Palm Beach, FL, 33408, US

(21) Appl. No.: 10/071,413

(22) Filed: Feb. 8, 2002

(51) Int. Cl. G01N 1/00

(52) U.S. Cl. 422/61

(57) ABSTRACT

A business method and means are provided to assist individuals accused of a DUI violation in a given state in the United States of America to preserve its legal rights that are provided by the statutes of that state. In addition to a membership card with indicia detailing the information needed to preserve the accused rights, a kit is provided that will allow a tester to have a urine sample analyzed by an independent laboratory. The business method contemplates having two additional members forming a unit team where each of the members become testers for the other member of the unit team.

This invention relates to a method for preserving legal rights of an individual and particularly to one's rights when a problem arises as a result of driving a motor vehicle when allegedly under the influence of alcohol (DUI). The invention includes a kit that is utilized when the method of preserving one's legal rights are implemented.

### BACKGROUND OF THE INVENTION

As is well known, it is typically a violation of law to drive a vehicle while one is under the influence of alcohol and that upon being accosted by a legal law enforcing officer for such an alleged violation, the individual in question is typically given a sobriety test. While it is not mandatory that the law enforcing officer requests that the individual in question is required to have the individual in question tested, if such a request is made, the individual in question has typically the right to have such test done by personnel of his own choosing. Hence, in a situation where the officer accuses an individual of a DUI, and the officer request that the driver take a sobriety test, the driver is obligated to take the test, but could request the officer that he would like to have an independent tester of his own choosing also make a test.

Obviously, this invention does not deal with the right or wrong of an individuals violations nor does it answer the question of how to resolve an issue where one who is so inebriated that the results of the tests would be obvious and thereby that individual should suffer the consequences of his act. However, this invention is a combination of a method, apparatus and business plan that addresses the problem that occurs in a situation where the accused is being charged with DUI where the circumstances are such that the accused may be unjustly accused. For example, in a situation where the accused is stopped by an official for failure to have a working tail light on his automobile, and the official happens to smell alcohol, be it from drinking alcohol, taking medication, or applying rubbing alcohol to his person, and the official requires the individual to take a sobriety test. The tests being done by the officer may not be sufficiently accurate whereby the individual is being unjustly charged on a test that produces fallacious results. In that situation the individual in question should be given the opportunity to have the test done by an independent tester. Interesting enough is the fact that most DUI occur in the late evening or early morning when it is difficult, if not impossible to have a test timely made. Under these circumstances, the individual in question cannot use that fact in his defense simply because of his inability of securing a test. Hence, under these circumstances my inventive method is efficacious because the individual in question has no problem in obtaining a tester at any time.

This invention is a method of assuring that an individual that has been charged with a DUI will be sufficiently knowledgeable with the aid of this method at the time of being accused that the accused will be able to preserve his rights to obtain a test by an independent tester. This method will enable the accused to respond to that situation no matter what time of day the incident occurs. The method includes providing the individual with a package that will be in his possession at the time of being accused which package contains the proper test equipment, the name and telephone number of the independent tester and the steps needed in protecting that individual's rights under these circumstances. The method requires at least the participation of three independent testers where one of the three is the accused. In a given situation, the accused will have a kit that includes a card with the information needed to respond to the charge being lodged against him, the name and a telephone number of the independent tester and a container to hold urine to be tested. The independent tester can meet with the accused, take a urine sample in the receptacle provided in the kit and take the sample to a testing facility or labratory where the test will be performed.

### SUMMARY OF THE INVENTION

An object of this invention is to provide a method for securing the rights of an individual that is being charged by a law enforcing officer with DUI.

A feature of this invention is providing three kits containing the names of the independent tester, a card outlining the steps needed to be taken by that individual and a receptacle for taking a urine sample that can be taken to a laboratory to be tested for alcohol content and obtaining individuals that will be responsible for each of the three kits. In other words, each of the kit owners will respond to a fellow kit holder that is being accused of DUI.

A feature of this invention is that the method and apparatus are simple to use, inexpensive and efficacious.

The foregoing and other features of the present invention will become more apparent from the following description and accompanying drawings.

### BRIEF DESCRIPTION OF THE DRAWINGS

FIG. 1 is a printed card of this invention that includes indicia that indicates the member's name, the membership number and the names of the other two testers and a statement about the applicable law;

FIG. 2 is an exploded view in perspective of the container holding the smaller containers for receiving the sample to be tested and a pouch to hold the smaller container of this invention;

FIG. 3A is a perspective view in elevation showing the inner containers and pouch stored in a sealed outer container of this invention;

FIG. 3B is a top view of the embodiment depicted in FIG. 1A with the top of the outer container removed; and

FIG. 4 is a view in perspective of the inner container and pouch after being used and ready to be transmitted for evaluation in accordance with the method of this invention.

These figures merely serve to further clarify and illustrate the present invention and are not intended to limit the scope thereof

### DETAILED DESCRIPTION OF THE INVENTION

While this invention is being described utilizing certain types of containers, pouches and the like, it should be understood that other types of transmitting devices can be utilized without departing from the scope of this invention. As used herein, the following definition are applicable.

Member means an individual that has purchased the kit and has accepted the responsibility of being a tester.

Tester means an individual that has purchased the kit and has become a member and has agreed to accept the sample that is being utilized for testing for alcohol content by a laboratory or the like.

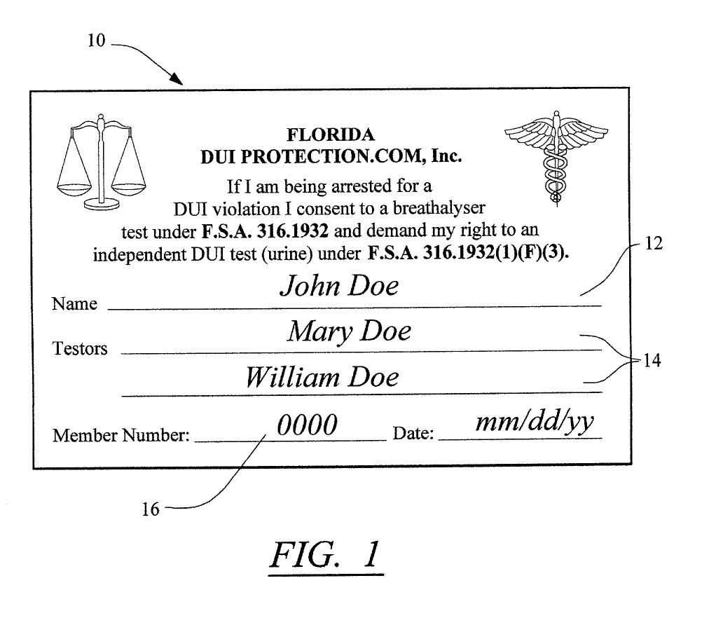

As mentioned in the above paragraphs, this invention is a method of doing business by providing a method for individuals that are accused of DUI to preserve his/her rights when the laws of a particular state of the United States are such that such rights are amenable to being preserved. The business method envisions a business organization that will be familiar with the laws of each of the states and will keep that information current selling to individuals in units consisting of three individual members where each of these members will take the responsibility of being a tester for each member of that membership unit. For example, a member will receive an identification card generally illustrated in FIG. 1 as reference numeral 10 and the card will include certain indicia including the name of the individual 12, two testers 14 and the member's membership number 16. Also, the card 10 will include information and directions pertinent to a given state's statute that will, when followed, will lead to protecting one's legal rights.

In this particular example, card 10 will be issued to members that are driving a motor vehicle or intend to drive a motor vehicle in the state of Florida and the direction given in the card 10 is that the individual member that is accused of a violation of the DUI statutes will consent to taking the testing offered by the government's agent and will demand, in return, the individual right as provided by the Florida laws, to have his own independent test. To this end, assuming the government's agent grants the accused permission to have his own independent test, the member will have available the kit provided to each of the members. Obviously, each member will be given directions that are conducive to the laws of the particular state where that individual drives or intends to drive a motor vehicle.

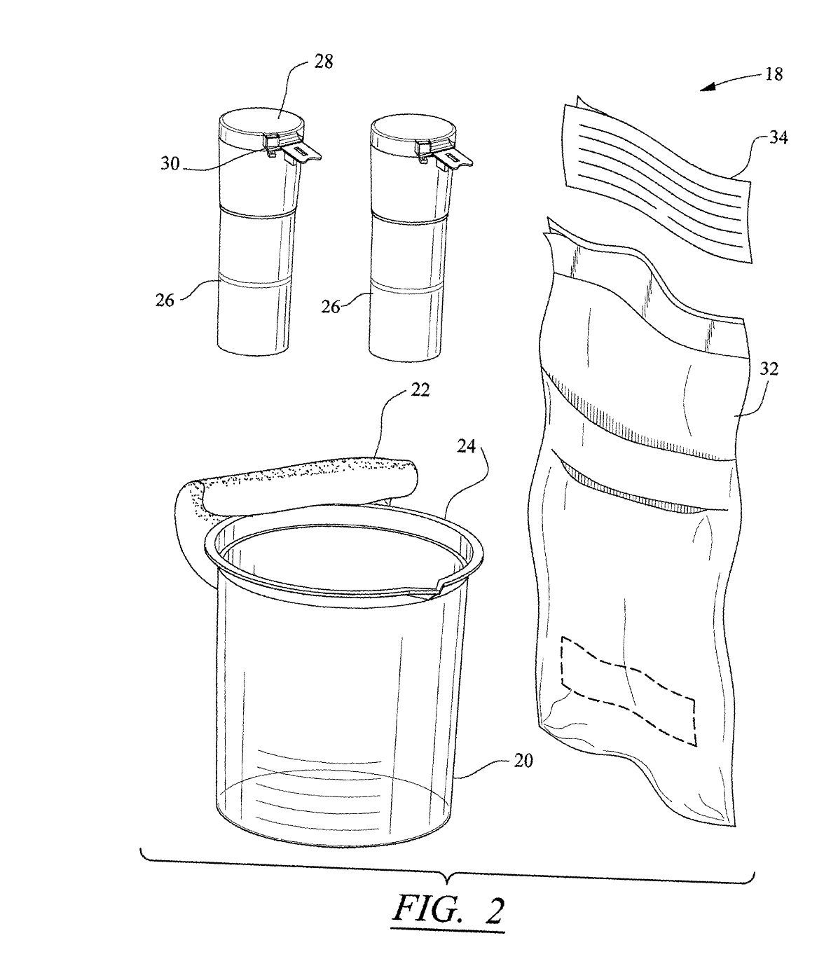

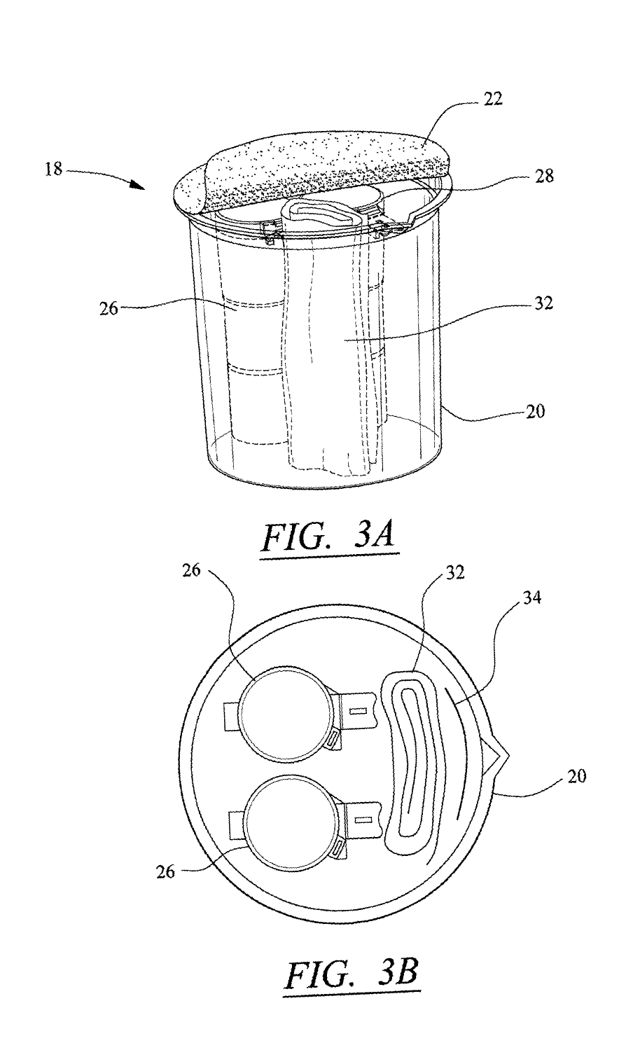

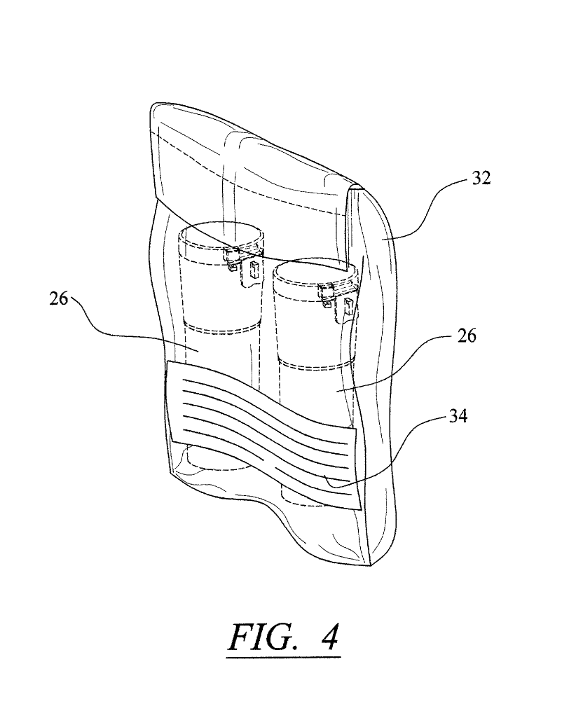

The kit is best shown in FIGS. 2A-4 and generally illustrated by reference numeral 18 consisting of the outer container 20 with a sealed top 22 made from a foil paper that is adhered to the top lid 24 of container 20. A pair of smaller containers 26 designed to hold the urine specimen of the accused is provided in outer container 20. Containers 26 may include a closure cap 28 that may also include movable locking members 30. Plastic pouch 32 with a stick-on tag 34 that has indicia allowing for identification information to be written thereon is provided. Each of these elements referred to in the above paragraph are commercially available and obviously, any deviation therefrom without departing from the function of the individual element will fall within the scope of this invention.

In operation, assuming a member is being accused of a DUI violation, the card 10 will be handed to the government agent. Assuming permission is granted by the government's agent to have an independent test, the accused will then be granted permission to call one of the designated tester from his unit who will arrive with the intent of delivering a urine sample to a qualified laboratory for an independent test. From the kit, the top sealed foil 22 of the kit 18 will be removed and the accused will be handed the smaller containers 26 to supply a urine sample. The sample will then, in turn, be placed in the pouch 32 with identifying information placed on the label to be attached to the outer surface of the pouch 32. The tester will then take the urine sample and deliver it to a laboratory for analysis.

Although this invention has been shown and described with respect to detailed embodiments thereof, it will be appreciated and understood by those skilled in the art that various changes in form and detail thereof may be made without departing from the spirit and scope of the claimed invention.

I claim:

1. The method of preserving the legal rights of an individual in a state that has laws governing the rights of individuals accused of a DUI violation from a government agent to have the right to an independent sobriety test, comprising the steps of
i) providing a membership card with indicia indicating directions for the member to accept the government agent's request for a sobriety test and requesting from the government agent the right to have a test done by an independent agency;
ii) providing a kit having a container for receiving a urine sample from the accused;
iii) the name of a pre-ordained tester for accepting the urine sample for delivering the container obtained in step ii to a laboratory capable of analyzing said urine sample.

2. The method of preserving the legal rights of an individual in a state that has laws governing the rights of individuals accused of a DUI violation from a government agent to have the right to an independent sobriety test as claimed in claim 1 including the step of providing an identification card with indicia stating the pertinent state statute and the instruction to accept the requested sobriety test made by the government official and requesting that the government official permit the independent sobriety test.

3. The method of preserving the legal rights of an individual in a state that has laws governing the rights of individuals accused of a DUI violation from a government agent to have the right to an independent sobriety test as claimed in claim 2 including the step of forming a unit of member tester that are available to a member of the unit when accused of a DUI violation.

4. Means for assisting an individual accused of a DUI violation to preserve that individual's legal right in obtaining an independent sobriety test when being charged by a government official, comprising a membership card issued by a business organization to each of said members with indicia providing the names of at least two individual member testers and instructions to accept a sobriety test offered by the government official and requesting an additional sobriety test for delivering a urine sample by one of said testers and a kit consisting of at least one container for storing a urine sample of the accused individual whereby a sobriety test of said urine sample can be done by an independent agency.

5. Means for assisting an individual accused of a DUI violation to preserve that individual's legal right in obtaining an independent sobriety test when being charged by a government official wherein said kit includes an outer container having a sealed removable top, an inner container in said outer container for holding a urine sample and a pouch in said outer container for transporting said inner container.

6. Means for assisting an individual accused of a DUI violation to preserve that individual's legal right in obtaining an independent sobriety test when being charged by a government official as claimed in claim 5 wherein said inner container includes cap means for sealing said inner container.

7. Means for assisting an individual accused of a DUI violation to preserve that individual's legal right in obtaining an independent sobriety test when being charged by a government official as claimed in claim 6 including a stick-on label having spaces for identifying the member being accused of the DUI violation.
